(19) United States
(12) Patent Application Publication
(10) Pub. No.: US 2006/0109240 A1
(43) Pub. Date: May 25, 2006

(54) Apparatus and method for enhancing the capability of the display output of portable devices

(76) Inventors: Rong Yao Fu, Beijing (CN); Hai Xin Chai, Beijing (CN); Guo Hui Lin, Beijing (CN); James Yeh Tien-Cheng, Beijing (CN); Xiao Xi Liu, Beijing (CN)

Correspondence Address: IBM CORPORATION (WM);C/O WEISS, MOY & HARRIS, P.C., 4204 NORTH BROWN AVENUE, SCOTTSDALE, AZ, 85251, US

(21) Appl. No.: 11/269,239

(22) Filed: Nov. 8, 2005

(30) Foreign Application Priority Data
Nov. 23, 2004 (CN) 200410095071.0

(51) Int. Cl. G09G 5/00

(52) U.S. Cl. 345/156

(57) ABSTRACT

An intelligent surrogate apparatus and method for enhancing the display output and interaction capability of a portable device. The apparatus comprises a communication interface for connecting the portable device and an display controller. In addition, the apparatus comprises a connection manager for establishing connection and managing data flows; a graphics data receiver for receiving structured graphics data output from an application running on the portable device via the communication interface and converting them to a corresponding graphic function invocation; and a windows manager which may invoke a graphic function library to organize application windows according to the graphic function invocation. The apparatus may comprise fully functional computer keyboard input and mouse input capability. It can organize windows on the external display and/or interact with the application program in response to an external keyboard/mouse event so that the portable device is endued with additional capabilities of interactive operations.

### FIELD OF THE INVENTION

The invention relates to portable devices, particularly to an apparatus and method for enhancing the capacity of the display output and interaction of the portable device.

### BACKGROUND OF THE INVENTION

Portable devices with computing capabilities, such as mobile phones and personal digital assistants (PDAs), are increasingly employed. When using such a portable device, a user may input commands or run application programs to cause the portable device to process data and display the result on a LCD screen. Because the LCD display is relatively small, the user sometimes may wish to display the graphics outputted by the application (also referred to as “application” for short) on another large external display device (also referred to as “external display” for short, e.g., PC's monitor).

U.S. patent application Ser. No. US2002/0080091 discloses a method and system of transmitting and displaying information of portable computing devices, which is incorporated herein in its entirety by reference. The patent application proposes an expansion module that includes a communication interface for linking the expansion module to a portable computing device with expansion slots, such as PDA. The expansion module also includes a storage device and an external display controller. When the expansion module is connected to the PDA, the PDA detects its presence. A microcontroller within the PDA (or within the expansion module) executes a control software to display a graphical control interface on the PDA's screen. The user may use this graphical control interface to manipulate the control software so that the PDA may display graphics data, such as presentation slides, on an external display. The control software first decodes the graphics data already stored in the portable computing device, and then passes the decoded graphics data to the expansion module via the expansion slots. The decoded graphics data are further converted into electronic signals before being transmitted to the external display.

The above-mentioned expansion module only decodes and transmits individual still graphics data stored in the PDA, for example, a plurality of frames of presentation slides. Therefore only such still graphics data may be displayed on the external display.

The expansion module of the US2002/0080091 only displays still images that have been edited in advance. Thus its application is limited. In a portable computing device, there are not only still images stored therein, but also many application programs. If interfaces for those application programs are to be displayed on the external display using the above-mentioned expansion module, a large number of consecutive still images have to be generated in real time, and then passed to the attached device for processing. That is not feasible for the resource-limited portable computing device.

Therefore, there is a need to improve the above-mentioned expansion module, such that the attached device can transmit and process graphics data in a more efficient way to realize real time displaying on an external display of instant graphics data outputted by application programs running in the portable device.

### SUMMERY OF INVENTION

One of the objects of the invention is to provide an intelligent surrogate apparatus and a control method to enable the output at an external display of structured graphics data generated by an application program (also referred to as application) running in an portable device, and allow the interaction with the application program via the external display to change the structured graphics data generated by the application program.

The present invention is based on the principle that, when running an application program in a portable device, the GUI (Graphic User Interface) outputted by the application program will be drawn by invoking a bottom-layer drawing function or API. If the GUI is to be displayed at a remote display, then it is merely needed to transmit the same drawing function invocation to the surrogate apparatus connected with the external display for execution. In this way, the amount of transmitted data can be effectively lowered and no extra computation is required, hence realizing the object of displaying the application program GUI of the portable device in real time and synchronously at an externally connected display or monitor.

Further, large portions of applications' GUI are described in markup languages. For example, the famous Internet application is based on the HTML language. With respect to this kind of special applications, the present invention, based on the above-mentioned principle, employs the method of transmitting the pages defined in a markup language to the, surrogate apparatus for parsing and processing by the intelligent processing unit at the surrogate apparatus, which may further decrease the data required to be transmitted and render the application program GUI at the external display more quickly.

In one aspect, the invention provides an intelligent surrogate apparatus for enhancing the display output capability of a portable device. The apparatus includes a communication interface for connecting the portable device and a display controller for providing display signals to an external display. In addition, the apparatus comprises an operation controller which comprises a connection manager for establishing connection and managing data flows; a graphics data receiver for receiving structured graphics data output from an application program running in the portable device via the communication interface and converting them to a corresponding graphic function invocation; and a windows manager for generating and/or closing application windows on the external display in response to connection establishment and/or disconnection, and for invoking a graphic function library to manage the application window according to the graphic function invocation.

According to a preferred embodiment, the intelligent surrogate apparatus may further connect to an external keyboard and/or mouse, and the operation controller may receive and interpret a keyboard/mouse event, and organize windows on the external display or interact with the application program.

Preferably, the intelligent surrogate apparatus may use high speed serial data interfaces, particularly USB interfaces. The advantage of using USB is its universality, i.e., capability of interfacing with varieties of intelligent portable devices with standard USB configurations.

Due to the above-mentioned structure, the intelligent surrogate apparatus of the invention may accept structured graphics data outputted by the application program, such as API and abstract markup language, dynamically compose graphics on the external display and organize displayed windows. The user may conveniently view the display output of the application running on the portable device on the external display and may perform interactive operations with the application via an externally connected keyboard and/or mouse.

Another aspect of the invention is to provide a method and a computer program for enhancing the display output capability of a portable device.

### BRIEF DESCRIPTION OF THE DRAWINGS

The accompanying drawings, as a part of the specification, are used to illustrate preferred embodiments of the invention and explain the principle of the invention together with the specification, wherein like references denotes like or similar elements.

FIGS. 1A and 1B illustrate an intelligent surrogate apparatus coupled to a portable device and a PC monitor in accordance with the present invention;

FIG. 2 illustrates a block diagram of the display surrogate apparatus in accordance with the present invention;

FIG. 3 illustrates a block diagram of an operation controller 109 in the intelligent surrogate apparatus as shown in FIG. 2;

FIG. 4 illustrates a flow chart of a connection manager in establishing a connection and transferring data between the portable device and the intelligent surrogate apparatus;

FIG. 5 illustrates a flow chart of operations by a windows manager in the operation controller as shown in FIG. 3;

FIG. 6 illustrates a flow chart of operations by a the service manager added to the operation controller according to an embodiment;

FIG. 7 is a block diagram illustrating a preferred embodiment of the intelligent surrogate apparatus; and

FIGS. 8A and 8B are diagrams illustrating the output of an application program displayed on the external display.

### DETAILED DESCRIPTION OF THE PREFERRED EMBODIMENTS

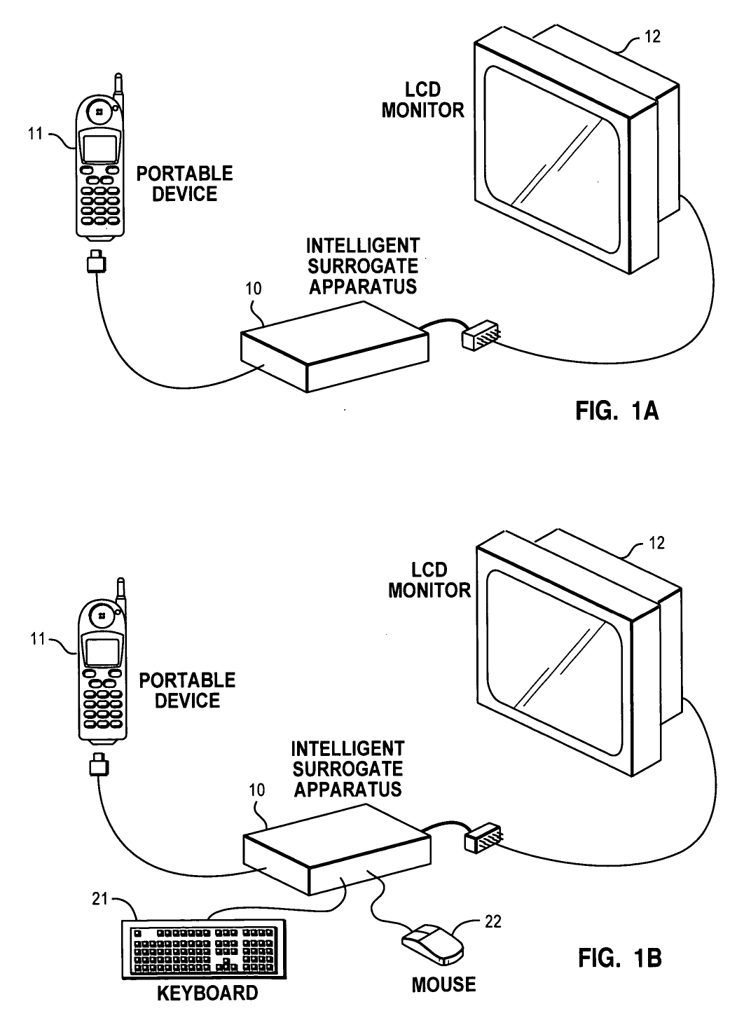

Referring now to FIG. 1, a system is presented in which an embodiment of the invention is implemented. As shown, the system includes a portable device 11, a LCD monitor 12 such as a PC display, and an intelligent surrogate apparatus 10 of the invention. The term portable device 11 as used herein refers to any of so-called “intelligent” devices capable of certain computation, including PDAs, mobile phones and the like. Such an intelligent device comprises processor and memory and can execute certain application programs, connect to the Internet and obtain contents such as HTML pages from the Internet. As an illustration, the mobile phone is used herein to represent the portable device. A customized driving agent between a conventional application and an interface in the mobile phone provides interactions between the intelligent surrogate apparatus 10 and the application running on the mobile phone 11, and forwards structured graphics data outputted by the running application for displaying on the external display 12.

FIG. 1B illustrates a system in which another embodiment of the invention is implemented. Compared to FIG. 1A, a keyboard 21 and a mouse 22 are added to the intelligent surrogate apparatus 10. By manipulating the keyboard and the mouse, a user can control the displaying on the external display 12 and realize interactions with the portable device 11.

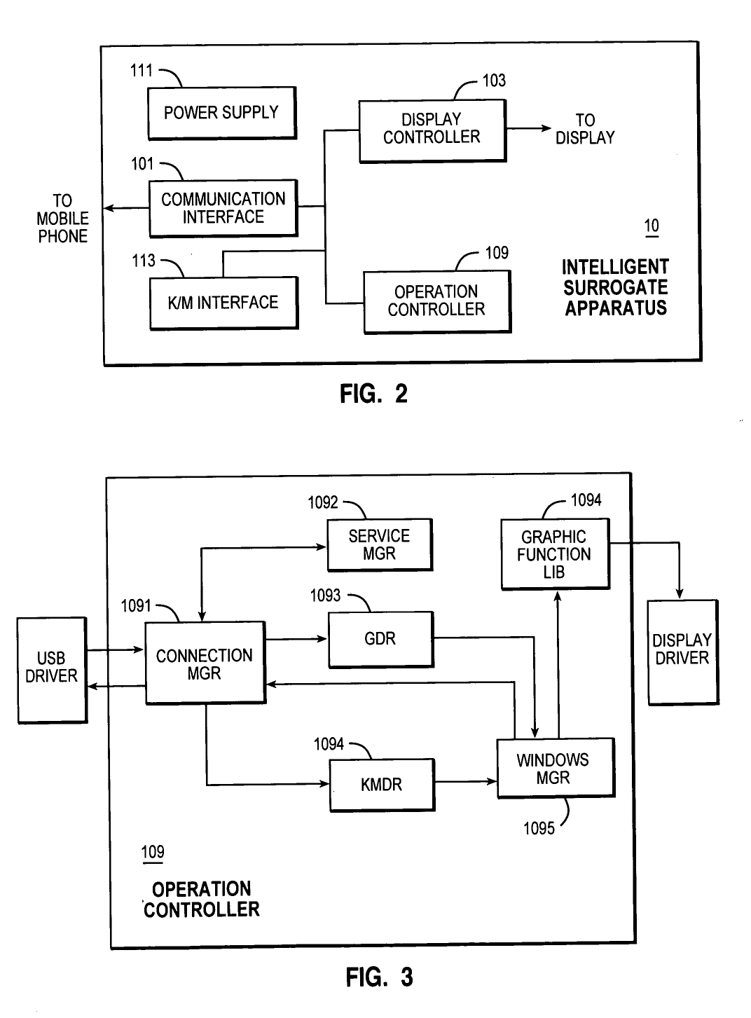

FIG. 2 illustrates a block diagram of the display surrogate apparatus 10 in accordance with the present invention. As shown in FIG. 2, the intelligent surrogate apparatus 10 comprises a communication interface 101. According to a preferred embodiment of the invention, the communication interface 101 is a high speed serial data port, such as a USB interface that may connect with the USB communication interface of the portable device under the control of a peripheral controller. The intelligent surrogate apparatus 10 may further comprise a display controller for converting digital signals to analog signals for transmission to the display 12, a microprocessor (not shown) for executing programs and a storage device (not shown) for storing instructions/data. The function and implementation of the above-mentioned components are well-known to those skillful in the art. For example, the communication interface acting as a USB interface may comprise a USB driver, and the display controller may comprise a display interface and an appropriate display driver. In an embodiment, the display interface may connect with the display 12 via a VGA cable (e.g., a 15-pin VGA cable with D-Sub connector). Also, the communication interface and/or display controller may comprise or connect with a peripheral controller for the control of the communication interface and/or display controller. For the purpose of brevity, detailed descriptions of the above-mentioned components are omitted here.

In addition to the above-mentioned components, the display surrogate apparatus 10 may also comprise an operation controller 109 for establishing data communication with the portable device 11, for receiving and interpreting structured graphics data, and for generating and organizing application window displayed on the external display.

Optionally, the display surrogate apparatus 10 may also comprise a power supply 111, such as a battery or a DC voltage input from an AID converter. Although the power supply within the portable device may be used, the advantage of the display surrogate apparatus 10 comprising an independent power supply is that there is no need to consume the power of the portable device so that its working time can be lengthened. Optionally, the display surrogate apparatus 10 may also comprise one or more interfaces 113, such as the USB interface, for connecting with the external keyboard 21 and/or mouse 22 to facilitate controlling the display of the external display further via the keyboard 21 and/or mouse 22.

FIG. 3 is a block diagram illustrating in detail the operation controller 109 of the intelligent surrogate apparatus as shown in FIG. 2. The basic components of the operation controller 109 of the invention include a connection manager 1091, a graphics data receiver (GDR) 1093 and a windows manager 1095. The connection manager 1091 is used to establish connection and manage data flows, for example, to connect with a high speed serial device such as a USB interface via the peripheral controller. The GDR 1093 is used to receive structured graphics data from the portable device 11 via the communication interface 101 and to convert the data to corresponding graphic functions for transmission to the windows manager 1095. According to an embodiment, the structured graphics data include for example a set of graphic function APIs or a markup language (such as HTML, XML, DHTML, etc.) page. If the structured graphics data is in a markup language, the GDR 1093 will further convert the data to corresponding graphic functions. The windows manager 1095 is used to generate and organizing application windows displayed on the external display. Specifically, the windows manager 1095 will generate and/or close application windows in response to the connection establishment or disconnection. During the period of connection, the windows manager 1095 will manage application windows displayed on the external display by providing basic graphics components and graphic function library of drawing functions based on the received data. Moreover, the windows manager 1095 will monitor window-related operation events and send relevant events back to the application on the portable device.

According to a preferred embodiment, the operation controller 109 may also comprise a keyboard/mouse data receiver (KMDR) 1094 for receiving keyboard/mouse events. Keyboard/mouse events refer to user actions in operating the keyboard 21/mouse 22 for controlling the display, for example, pressing a key or clicking/scrolling the mouse. In this embodiment, the windows manager 1095 is further configured to organize windows on the external display 13 in response to keyboard/mouse events.

Specifically, after receiving a keyboard/mouse event, the windows manager 1095 will interpret the keyboard/mouse event. If it is a window event, the windows manager 1095 will correspondingly organize windows on the external display, for example, move a window, adjust the size of a window, or put a window in focus or out of focus. If the keyboard/mouse event is an internal component event of the application, for example, a click on a menu option output by the application, the windows manager 1095 will distribute the event to the portable device 11 via the connection manager 1091, for processing by the running application, whereby the output of the application is changed and in turn reflected on the external display 13.

According to a preferred embodiment, a service manager 1092 may also be added to the operation controller 109. As is known by those skillful in the art, the service manager may collect information about devices on the surrogate apparatus, for example, the characteristic parameters of the external display, the keyboard and the mouse. If the customized driving agent in the portable device is negotiated to provide the information on peripheral devices, the application will be able to use this kind of information to run in a better way. According to prior art, normally the above-mentioned device information may be packaged in the form of services, also referred to as device services or services. And the module for implementing the above-mentioned functions is called “service manager”.

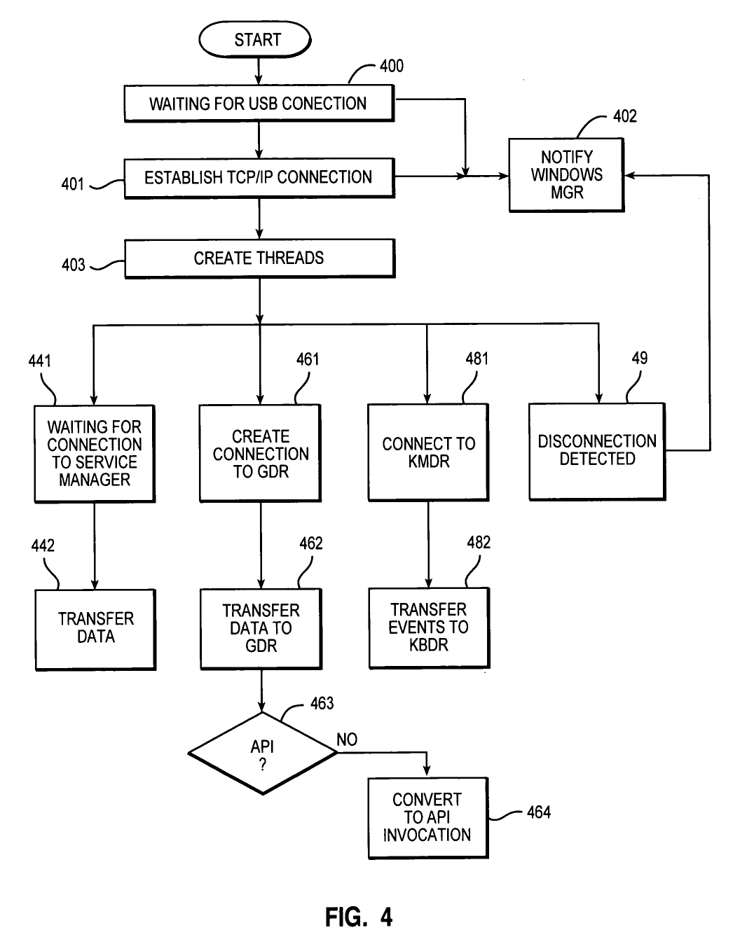

The operations by the operation controller will be further described below with reference to FIGS. 4, 5 and 6.

FIG. 4 illustrates a flow chart of the connection manager 1091 in establishing a connection and transferring data between the portable device and the intelligent surrogate apparatus. In Step 400, a connection to the USB of the intelligent surrogate apparatus is listened to. The USB is a plug-and-play port. Listening to the connection to the USB is well known in the prior art and thus will not be described in detail. In an embodiment, Step 400, for example, may be implemented by a call-back routine of the USB driver. At Step 401, a TCP/IP connection is established between the portable device and the intelligent surrogate apparatus, providing a media-independent communication channel for subsequent data transfer. Whenever a connection is established at Step 400 or 401, Step 402 is performed, notifying the windows manager of the message of this connection so that the windows manager will change the display output accordingly. The process then proceeds to Step 403, where multiple waiting/monitoring threads are created to be executed simultaneously.

The first thread starts at Step 441, where a TCP/IP socket is created and a connection to the service manager at a specific port is listened to. At Step 442, the data transferred via the connection between the portable device and the display surrogate apparatus is transferred to the service manager 1092.

The second thread starts at Step 461, where a connection to GDR 1093 is created. Then, at Step 462, structured graphics data is transferred to GDR 1093 via the connection. At Step 463, determination is made as to whether the structured graphics data is of API type or not. If not, Step 464 is performed, where GDR 1093 converts the received structured graphics data to API format.

The third thread starts at Step 481, where a connection to the keyboard/mouse data receiver (KBDR) 1094 is established. At Step 482, keyboard/mouse events are transferred to KBDR via the connection.

The fourth thread starts at Step 49, where break of TCP/IP connection or USB connection is detected. Then Step 402 is performed to transfer the break message to the windows manager so that the later will update the display output accordingly.

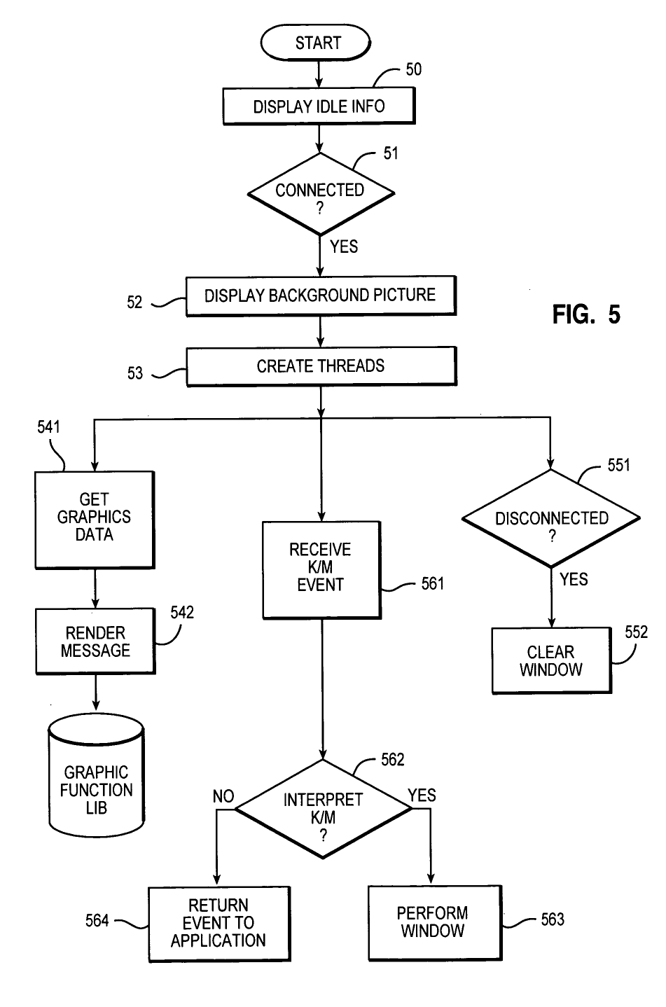

Refer now to FIG. 5, a flow chart showing operations by the windows manager of the invention. At Step 50, the display is in idle or standby state. In this state, the windows manager is waiting for messages from the connection manager 1901 about USB and TCP/IP connection. At this time, the windows manager may display some message, for example, screen wallpaper, to indicate that state. At Step 51, a determination is made to decide whether a device is connected. If yes, then at Step 52, a background picture is displayed on the monitor to indicate the device is connected. Then the process proceeds to Step 53, where a plurality of concurrently executed threads is created.

The first thread starts at Step 541, where the graphic function is received from GDR 1093 and converted to messages that can be understood by the windows manager 1095 by invoking the graphic function library. At Step 542, the messages are rendered as individual windows displayed over the background picture.

The second thread starts at Step 551, where it monitors whether the connection is broken. If yes, Step 552 is performed to clear the windows displayed on the monitor.

According to the preferred embodiment of the invention as mentioned above, the intelligent surrogate apparatus may also connect with an external keyboard/mouse. In such an embodiment, the windows manager 1095 will also create a third thread. The thread starts at Step 561. At Step 561, a keyboard or mouse event (input) is received by the windows manager 1095. At Step 562, the keyboard or mouse event is interpreted by the windows manager. If the received event can be mapped to a window event, at Step 563, the monitor is controlled to perform a corresponding operation, such as window movement, window re-sizing or highlighting one of the windows. If it is not a window event, which indicates that the target of the event is a component internal to the application, the windows manager will distribute the interpreted event data to the application of the portable device (Step 564).

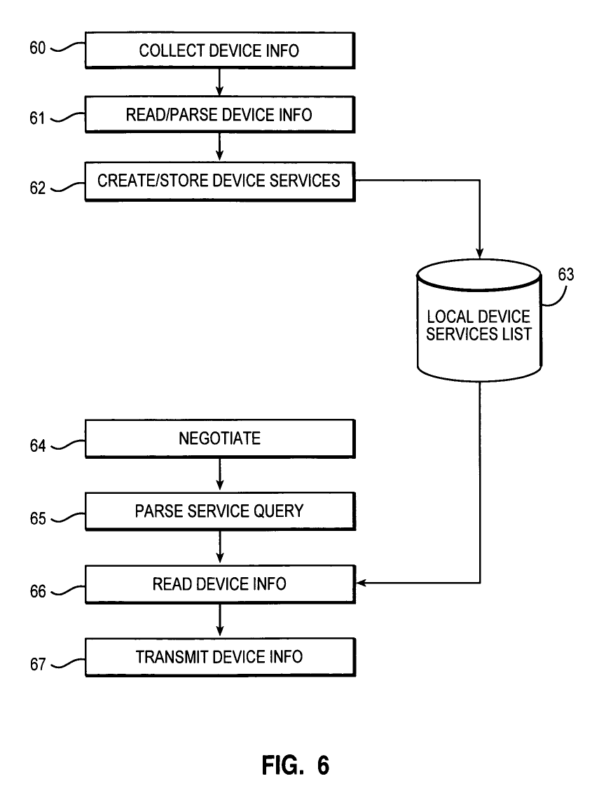

FIG. 6 illustrates a flow chart of operations of the service manager 1092 in collecting device information, negotiating between the portable device 11 and the intelligent surrogate apparatus 10 and sending the device information, according to a preferred embodiment.

At Step 60, the service manager 1092 monitors and searches peripheral devices on the intelligent surrogate apparatus 10. At Step 61, the information about the peripheral devices, such as screen size of the external display, the color depth, presence of a keyboard 21/mouse 22 and the specifications of the keyboard/mouse, is read and parsed. At Step 62, the above information is encapsulated as a uniform form of services and a list of device services 63 is created locally for query and retrieval. The services list 63 may be stored in a storage device.

The service manager 1092 may also provide the above information to the portable device. At Step 64, when a connection is established between the portable device 11 and the intelligent surrogate apparatus 10, the service manager 1092 will negotiate with the driving agent within the portable device 11 and set up a channel for service query. At Step 65, a device service query is received and parsed by the service manager 1092. Next, at Step 66, the device information is read based on the query and retrieval of the list of device services 63. At last, at Step 67, the relevant device information service is returned to the portable device 11.

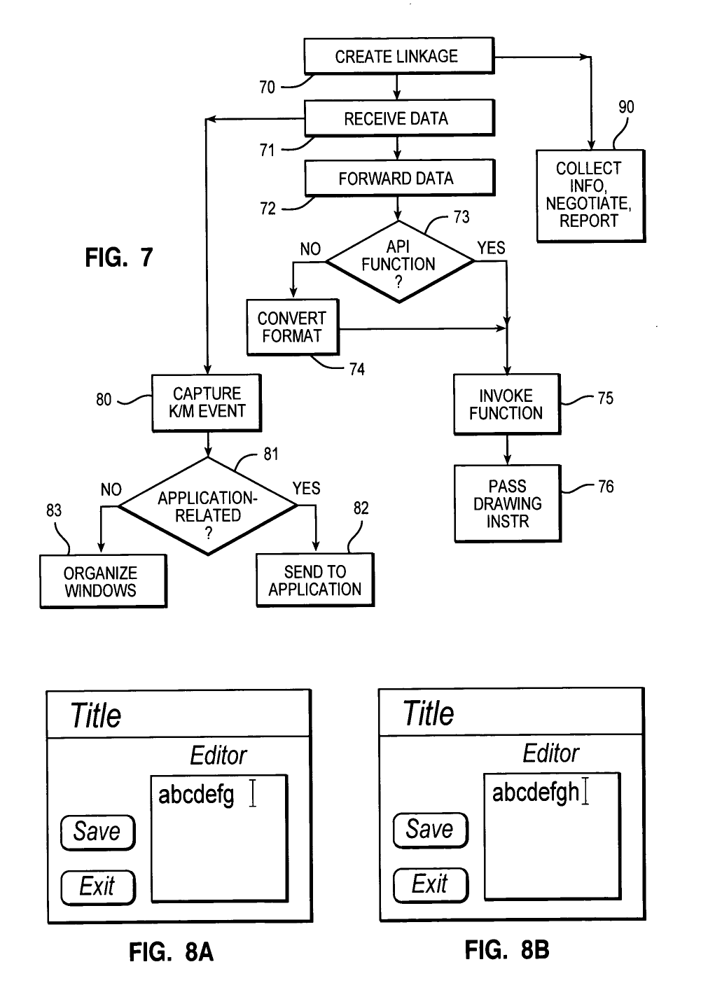

FIG. 7 is a block diagram illustrating the work flow of a preferred embodiment of the intelligent surrogate apparatus of the invention.

At Step 70, physical connections are established between peripheral devices (such as external display 12, keyboard 21/mouse 22) and the intelligent surrogate apparatus 10, and a physical connection is established between the portable device 11 and the intelligent surrogate apparatus 10. The connection manager 1091 establishes TCP/IP connections on the physical links to provide channels for data transfer.

At Step 71, the connection manager 1091 receives structured graphics data from the portable device 11, which is output by the application initiated at the portable device 11. Specifically, the application passes interface-drawing instructions in the form of structured graphics data (such as graphic API or markup language) to the surrogate apparatus 10 stage by stage via the driving agent and the established data transfer channels.

At Step 72, the connection manager forwards the received data to GDR 1093. If the type of the data is graphic API function, (Step 73, yes), GDR 1093 sends the data directly to the windows manager 1095; otherwise, if the type is markup language, then an embedded interpretation converter is invoked to convert the data in markup language to the form of graphic API function before sending it to the windows manager 1095.

According to a preferred embodiment of the invention, the markup language can be converted in the following way. For example, the code “<HR>” in a HTML page represents drawing a horizontal line. When interpreting the HTML page, GDR 1093 will convert the code to a line-drawing API function (pseudo code: drawLine (relative coordinates of the starting point, relative coordinates of the end point, [default color], [default line width]) function) for invocation by the windows manager 1095 in rendering the page.

At Step 75, the windows manager 1095 will, on the basis of the received graphic API function for drawing GUI, invoke the graphic function library to generate drawing instructions. At last, at Step 76, the drawing instructions are passed to the display controller for drawing the interface of the application on the external display.

According to an embodiment of the invention, after physical connections are established between peripheral devices and the intelligent surrogate apparatus 10 at Step 70, the windows manager 1092 will collect device information of individual peripheral devices, generate and store a list of device services 63. After the TCP/IP connection is established, the service manager 1092 will negotiate with the driving agent on the portable device 11 and report the service information. The portable device 11 will issue service queries and obtain information about available peripheral devices from the list of device services 63 via the service manager 1092. The above process is denoted by Step 90. The information on peripheral devices thus obtained may be used for configuring application programs.

According to an embodiment of the invention, in case of presence of the keyboard 21/mouse 22, a user's actions through the input of such input devices will be captured and interpreted by the windows manager 1095 (Step 80). If the input event is an application related event (block 81, Yes), the windows manager may feed the parsed event data back to the portable device 11 via the channel for data transfer (Step 82) to realize the user's interaction with the application. Otherwise (block 81, No), the windows manager will organize application windows according to the input (Step 83).

FIGS. 8A and 8B illustrate the interface of an example application. As a text editor, the application has graphics components such as a window body (including a title “Title”, etc.) of the application, a text editing box, buttons for save (“Save”) and exit (“Exit”). The function of the application program is editing and storing a text file in the portable device. When the program is running, designated contents of the text file are displayed in the text editing box (pseudo code: showText (coordinates, “abcdefg”) function). The user's input operation will be notified to the application instantly. For example, if the key “h” is pressed when the cursor is in the text editing box, the event will be fed back to the application and the application will add the newly inserted text “h” at the end of the existing text (pseudo code: appendText (coordinates, “h”) function). Then the text in the editing box will be updated and displayed as “abcdefgh”. Also, the user's mouse click operation on the button “Save” will be fed back to the application, eventually causing the text content to be written back to the storage medium on the portable device 11 (e.g. in a file or DB). As another aspect, the windows manager 1095 will also organize application windows according to input events, for example, move a window, zoom in or zoom out a window, put a window in focus or out of focus, etc.

The above description of the invention has been given by way of example with reference to preferred embodiments implementing the invention. However, details of the above description and embodiments are not to be construed as limitations to the scope of the invention. For example, separate components as described above, e.g., the graphics data receiver, the keyboard/mouse data receiver and the windows manager, may be integrated in one and same component. As another example, the functional features and steps described in the embodiments may be implemented in the form of hardware, software or their combination. For example, the operation controller in the embodiment may take the form of a single IC module or a combination of ICs, and may also be implemented in software executable by a microprocessor. With the teachings of the present description, various modifications may be made to the embodiments of the invention by those skillful in the art without departing the scope and spirit of the invention.

1. An apparatus for enhancing the display output capability of a portable device, the apparatus including a communication interface for connecting the portable device and a display controller for providing display signals to an external display, characterized that the apparatus includes an operation controller which comprises:
a connection manager for establishing connection and managing data flows;
a graphics data receiver for receiving structured graphics data output from an application running on the portable device via the communication interface and converting them to corresponding graphic function invocations; and
a windows manager for generating or closing application windows on the external display in response to connection establishment or disconnection, and for invoking a graphic function library to organize the application windows according to said graphic function invocation.

2. The apparatus as recited in the claim 1, further comprising one or more additional interfaces for connecting to a keyboard and/or mouse, and the operation controller further comprising a keyboard/mouse data receiver for receiving a keyboard/mouse event, wherein the windows manager is further configured to be capable of organizing the windows on the external device in response to the keyboard/mouse event.

3. The apparatus as recited in the claim 2 wherein organizing the windows on the external device in response to the keyboard/mouse event includes operations of interpreting the keyboard/mouse events and controlling window movement, adjusting window size, or putting the window in focus or out of focus on the external display, or any combination of the operations.

4. The apparatus as recited in the claim 2 wherein organizing the windows on the external device in response to the keyboard/mouse event includes operations of interpreting the keyboard/mouse event and distributing internal component events of the application to the portable device for further processing by the application.

5. The apparatus as recited in claim 1 wherein the operation controller further comprises a service manager for collecting information on the peripheral devices of the apparatus and providing the information to the portable device.

6. The apparatus as recited in claim 1 wherein the communication interface is USB interface.

7. The apparatus as recited in claim 2 wherein the additional interface is USB interface.

8. The apparatus as recited in claim 1, further comprising an independent power supply.

9. The apparatus as recited in claim 1 wherein the structured graphics data include graphics API.

10. The apparatus as recited in claim 1 wherein the graphic function invocation is API invocation.

11. The apparatus as recited in the claim 10 wherein the structured graphics data further include a markup language.

12. The apparatus as recited in the claim 11 wherein the markup language is one from the group consisting of HTML, XML and DHTML.

13. A method for enhancing the display output capability of a portable device implemented on an apparatus connecting the portable device with an external display, the apparatus comprising a microprocessor, a storage device, a communication interface for connecting the portable device and a display controller for providing display signals to the external display, the method comprising the following steps:
establishing a connection between the portable device and the external display;
receiving structured graphics data output from an application on the portable device;
converting the structured graphics data to corresponding graphic function invocations; and
invoking a graphic function library to organize application windows according to said graphic function invocation.

14. The method as recited in the claim 13, further comprising the following steps:
generating application windows on the external display in response to establishment of the connection; or
closing application windows on the external display in response to break of the connection.

15. The method as recited in the claim 13, further comprising:
receiving a keyboard/mouse event;
interpreting the keyboard/mouse event;
organizing windows on the external device in response to the keyboard/mouse event if it is a window event; otherwise, distributing the interpreted event data to the application of the portable device.

16. The method as recited in the claim 15 wherein organizing windows on the external display includes operations of window movement, window re-sizing, window focusing-in or focusing-out on the external display and the combination of those operations.

17. The method as recited in claim 13, further comprising the following steps:
collecting the information on the peripheral devices of the apparatus; and
providing the information to the portable device.

18. The method as recited in claim 13 wherein the structured graphics data includes APIs and markup languages.

19. The method as recited in claim 13 wherein the graphic function invocation is API invocation.

20. The method as recited in the claims 17 wherein the markup language includes one from the group consisting of HTML, XML and DHTML.
